(19) United States
(12) Patent Application Publication
(10) Pub. No.: US 2021/0389724 A1
(43) Pub. Date: Dec. 16, 2021

(54) HOLOGRAPHIC DISPLAY SYSTEM

(71) Applicant: Northwestern University, Evanston, IL (US)

(72) Inventor: Oliver Strider Cossairt, Evanston, IL (US)

(21) Appl. No.: 17/270,774

(22) PCT Filed: Sep. 16, 2019
(86) PCT No.: PCT/US2019/051292

§ 371 Date: Feb. 23, 2021

Related U.S. Application Data
(60) Provisional application No. 62/731,280, filed on Sep. 14, 2018.

(51) Int. Cl. G03H 1/04; G03H 1/12; G03H 1/08

(52) U.S. Cl. CPC G03H 1/0465; G03H 1/0476; G03H 1/12; G03H 1/0866; G03H 2223/14; G03H 2225/60; G03H 2210/30; G03H 2223/13; G03H 2001/0482

(57) ABSTRACT

A three-dimensional (3D) display system includes a reference spatial light modulator configured to generate a reference wavefront. The system also includes an object spatial light modulator configured to generate an object wavefront. The system further includes a Hogel basis display positioned between the reference spatial light modulator and the object spatial light modulator. The Hogel basis display is configured to receive the reference wavefront and the object wavefront. The Hogel basis display is also configured to generate a light field based at least in part on interference between the reference spatial light modulator and the object spatial light modulator.

### CROSS-REFERENCE TO RELATED APPLICATION

The present application claims the priority benefit of U.S. Provisional Patent App. No. 62/731,280 filed on Sep. 14, 2018, the entire disclosure of which is incorporated by reference herein.

### BACKGROUND

Current technologies enable creation of large format analog holograms that provide stunning realism. Such holograms are able to give viewers the impression of a complete three-dimensional (3D) picture frozen in time. For example, back in 1972, the Cartier jewelry store displayed a hologram of a hand holding jewelry in the window storefront on 5^{th} Avenue in New York City. The hologram reportedly looked so realistic that an elderly woman passing by tried to attack the virtual hand floating in the air. Additionally, for static objects such as historical museum artifacts, archaeological findings, architectural models, prototypes, etc., full color holography offers a realism on par with visual inspection of the actual object.

### SUMMARY

An illustrative three-dimensional (3D) display system includes a reference spatial light modulator configured to generate a reference wavefront. The system also includes an object spatial light modulator configured to generate an object wavefront. The system further includes a Hogel basis display positioned between the reference spatial light modulator and the object spatial light modulator. The Hogel basis display is configured to receive the reference wavefront and the object wavefront. The Hogel basis display is also configured to generate a light field based at least in part on interference between the reference spatial light modulator and the object spatial light modulator.

An illustrative method of displaying 3D objects includes generating, by a reference spatial light modulator, a reference wavefront. The method also includes generating, by an object spatial light modulator, an object wavefront. The method also includes receiving, by a Hogel basis display positioned between the reference spatial light modulator and the object spatial light modulator, the reference wavefront and the object wavefront. The method further includes generating, by the Hogel basis display, a light field based at least in part on interference between the reference spatial light modulator and the object spatial light modulator.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 depicts a data-driven 3D display system in accordance with an illustrative embodiment.

FIG. 2A depicts the exposure process for a Hogel basis screen in accordance with an illustrative embodiment.

FIG. 2B depicts the recording process for the Hogel basis screen in accordance with an illustrative embodiment.

FIG. 3A depicts a first recording process for a 3D display system with a Hogel basis screen in accordance with an illustrative embodiment.

FIG. 3B depicts a second recording process for the 3D display system with the Hogel basis screen in accordance with an illustrative embodiment.

FIG. 3C depicts a playback process for the 3D display system with the Hogel basis screen in accordance with an illustrative embodiment.

FIG. 4 is a flow diagram depicting a recording process for a 3D display system in accordance with an illustrative embodiment.

FIG. 5 is a block diagram of a computing system 500 for a 3D display system in accordance with an illustrative embodiment.

FIG. 6 depicts a data-driven 3D display system in accordance with another illustrative embodiment.

FIG. 7A depicts a digital holographic printer system in accordance with an illustrative embodiment.

FIG. 7B depicts a multiplexed digital holographic printer system in accordance with an illustrative embodiment.

FIG. 8 depicts geometry of a light field display in accordance with an illustrative embodiment.

FIG. 9 shows an autoencoder DNN architecture (HBS-NN) that incorporates the physical constraints of optical propagation through an HBS volume hologram in accordance with an illustrative embodiment.

FIG. 10 depicts a 2D display prototype in accordance with an illustrative embodiment.

FIG. 11A illustrates the principle of playback for a FIBS 3D display in accordance with an illustrative embodiment.

FIG. 11B illustrates compressed time-of-flight (ToF) 3D imaging in accordance with an illustrative embodiment.

FIG. 12A depicts a programmable reflectance 3D display in accordance with a first illustrative embodiment.

FIG. 12B depicts a programmable reflectance 3D display in accordance with a second illustrative embodiment.

### DETAILED DESCRIPTION

In the past, three-dimensional (3D) display design has been largely dominated by physicists and electrical engineers who are strongly focused on accurate physical synthesis of optical fields, with little attention paid to the importance of the displayed content. This approach ignores a critical piece of insight shared by all modern researchers in computer science, data science, statistics, image processing, machine learning, and astronomy. This insight is that the space of all possible naturally occurring high dimensional signals spans an exceptionally small portion of the space occupied by all possible signals. Most of the space is occupied by noise. Described herein are hologram displays methods and systems that capitalize on this notion to fundamentally transform the principles of 3D image synthesis towards a new paradigm of data-driven 3D display design.

A number of different three-dimensional (3D) display technologies have developed over the years, including integral/lenticular/barrier/lightfield displays, holographic photography, digital holographic printers, and holovideo displays. Brief descriptions of these technologies are included below.

Integral and parallax barrier displays were introduced more than a century ago, leading to the development of integral/lenticular/barrier/lightfield displays. Originally these displays were presented in the form of static 3D displays with fixed imagery. In operation, these displays essentially convert the pixels mapped onto a two-dimensional (2D) surface into a set of four-dimensional (4D) rays, where the total number of rays that can be generated is equal to the number of pixels (space-bandwidth product ((SBP)). The advantage of producing static imagery is SBP in excess of 10¹² over meter sizes due to well-established advances in print technology. The same principle has been demonstrated extensively in various forms with large format liquid crystal displays (LCDs) and rear projection screens with other types of spatial light modulators (SLMs). Using SLMs provides an advantage over print, namely that dynamic/programmable content can be displayed. However, the display of dynamic/programmable content comes at a cost of reduced SBP (on the order of 10⁶ instead of 10¹²), dramatically reducing the fidelity of 3D imagery that can be displayed. This limitation can be somewhat overcome with the use of multiple SLMs, but unfortunately the cost per SLM has remained prohibitively expensive so as to limit SBP to the order of 10⁶-10⁸ pixels/rays, even for the most state of the art displays.

Analog holography (or holographic photography) was popularized by the pioneering research of Leith and Eupatniks that followed the invention of the LASER in the 1960's and 1970's. Analog holography, uses high resolution photosensitive film to record interference fringes with a resolution close to the wavelength of light. In a large format hologram (e.g. 1 m×1 m) generated with this technology, the information density is high, resulting in 3D images that are displayed with stunning realism. In some cases the imagery is so realistic that it is almost impossible to distinguish from a real object. Unfortunately, interferometric holography is restricted to imagery that can be recorded in a laboratory environment, and the high information density recorded on an analog hologram is extremely difficult to replicate using programmable SLMs.

The Spatial Imaging group pioneered the concept of a Digital Holographic Printer in the 1980's and 1990's. The primary concept was to digitally record a high resolution light field, either by synthesizing 3D computer graphics renderings, or by capturing a large multitude of imagery from different viewing positions. Decoupling the acquisition and printing process allowed, for the first time, 3D imagery to be displayed of objects located outside of laboratory environments. At the same time, because the holograms were recorded on very high resolution analog film, the process enabled the recording of light fields with SBP approaching that of the analog holograms that were popular in the 60's and 70's.

In the 1990's, Zebra Imaging, Inc. was formed to commercialize digital holographic printer technology, and the concept of a “Hogel,” or holographic pixel was introduced. A Hogel is a fundamental unit of a digital holographic print, or the equivalent of a pixel in 2D print. One Hogel is printed at a time, and that Hogel encodes the set of rays that should emanate from that spatial location on the hologram surface. This technology was used to produce some of the most stunningly realistic 3D digital prints ever created. Zebra Imaging also forayed into light field displays, producing some stunning dynamic 3D imagery that capitalized on the available expertise in SLM technology and holographic printing. However, these light field displays suffered from the same limitations in SBP as conventional integral/parallax barrier displays.

Regarding holovideo displays, when Stephen Benton invented the rainbow hologram at Polaroid in the 1970's, he thought he had made the first step in developing a practical implementation of holographic video. Benton knew that the SBP of analog holograms was beyond anything that could be achieved with commercial SLM technology available at the time. However, he realized that by reducing the hologram to Horizontal Parallax Only (HPO), the SBP could be achieved over reasonably small hologram sizes. This led to the first implementations of holographic video, which utilized high bandwidth multi-channel acousto-optic modulators, high speed scanning mirrors, and a very large objective lens. The system had various incarnations that produced relatively wide field of view (FoV) HPO 3D imagery (˜30 degrees), with a reasonably large image size (˜100 millimeters (mm)), but was notoriously difficult to align and synchronize. Further developments in holovideo utilized high bandwidth ferro-electric SLMs coupled with optically-addressable SLMs to achieve similar SBP with dramatically simplified alignment and synchronization. Higher bandwidth SLMs have also been explored using alternative physical processes, but the above-described holovideo displays remain the closest implementations to achieve practical large area, wide-FOV based holographic fringe projection.

While engineers and scientists have nearly mastered the recording and display of static 3D imagery, dynamic display has proved to be an elusively challenging task. As discussed above, many visually compelling 3D displays have been built in the last few decades. However, scientists and engineers have yet to truly deliver on the ultimate goal of a dynamic, holographic quality 3D display. The data sizes and rates required to display dynamic, holographic quality 3D imagery over a large area and FOV becomes more manageable each year that Moore's law advances. However, the data sizes still remain so astronomically large as to be fundamentally impractical for decades to come. What is needed is a transformational approach to the problem of 3D display design that fundamentally rethinks the problem and breaks the current trend of incremental advances.

Content adaptive 3D displays operate on a fundamentally different principle than other types of 3D displays. Content adaptive 3D displays operate based on the concept that two layered 2D SLMs can be considered as a rank-1 factorization of a 4D light field. As a result, by quickly sequencing through a set of images on two displays at a rate higher than the integration time of the human eye, a high rank approximation of a light field can be achieved. The technique was the first to utilize the limited SBP afforded by commercial SLMs to produce 3D imagery using a content-specific light field basis. This original idea can be extended to include multiple stacked SLMs, as well various combinations of low resolution light fields and 2D SLMs.

The embodiments described herein are based in part on the above-described concept of content adaptive 3D displays. However, for the embodiments described herein, the bases used are different for each light field displayed. The bases are rank-1 factorizations of a given light field, which is essentially a singular value decomposition (SVD) basis learned from that single light field. The 3D display concepts introduced herein are inspired by the notion of displaying light fields in a learned basis. However, the proposed systems introduce the concept of displaying imagery in a fixed light field basis that is learned from a training database of example light fields. Furthermore, the proposed system utilizes the concept of a hogel screen to display light fields with exceptionally high SBP (e.g., 10¹² rays), while utilizing only a small number of degrees of freedom on a programmable SLM (e.g., 10⁶ pixels).

The proposed methods and systems sidestep the infeasibly difficult problem of creating a 3D display that is able to reproduce all possible light fields that are within the realm of physical possibility. Optical physics dictates that recreating an accurate 3D optical field with a hemispherical FOV involves light modulation at the resolution of a single wavelength (e.g. 0.5 micrometers (um)). Hemispherical FOV over a 1 meter (m) viewing surface requires a space-bandwidth product (SBP) on the order of (1 m/0.5 um)²=4*10¹², which is a very large number. Currently available programmable spatial light modulators (SLMs) are unable to achieve such high SBP at a reasonable cost. However, there are methods to create optical recordings that exceed this SBP, doing so only at a fixed point in time. The methods and systems described herein capitalize upon these optical recording techniques to produce 3D displays with unprecedented realism and the ability to be programmed dynamically using only the limited degrees of freedom offered by commercially available SLM technology.

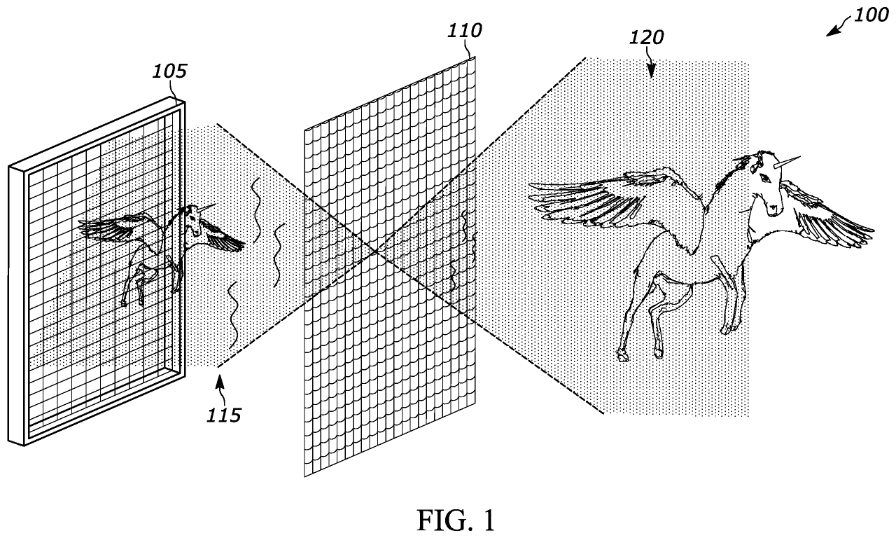

Specifically, the proposed approach is to develop a display that only aims to reproduce the set of light fields that are within the realms of physical plausibility. The advantage of this approach is that is can drastically decrease the degrees of freedom necessary to dynamically program a display. The approach is based on the largest set of physically plausible light fields that can be recovered from the approximately 2*10⁶ dynamic degrees of freedom offered by a single commercially available SLM. The core idea is outlined in FIG. 1, in which a 2 megapixel SLM is used to create a light field of 2 million rays. Architectures that use multiple SLMs to produce larger net SBP can be used in alternative embodiments.

FIG. 1 depicts a data-driven 3D display system in accordance with an illustrative embodiment. The system 100 includes an integral imaging display 105 that includes a large format liquid crystal display with a lens array placed in front of it. The system 100 also includes a Hogel basis screen (HBS) 110, which is described in more detail below. The integral imaging display (or plenoptic integral display) 105 is used to generate a low resolution (LR) light field 115. The number of pixels on the LCD of the integral imaging display 105 limits the space-bandwidth product (SBP), and hence the number of programmable rays to about 10⁶. The low resolution light field 115 is projected onto the HBS 110, as shown. The HBS has recorded a fixed holographic basis with SBP on the order of 10¹² rays, producing a high resolution (HR) light field 120, which is a free floating light field providing imagery with unprecedented 3D realism. Though the HBS records a fixed HR light field basis, the basis is learned from a training database that includes naturally occurring light fields. As a result, nearly all HR light fields can be reproduced with a high degree of accuracy, using only the limited degrees of freedom available in a low resolution LCD, such as the one in the integral imaging display 105.

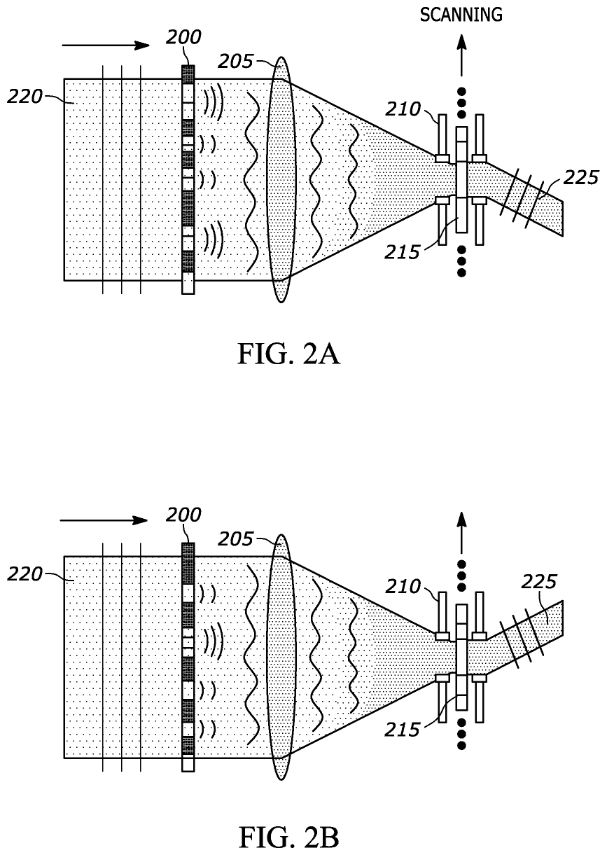

As discussed with reference to FIG. 1, the proposed embodiments introduce the concept of the Hogel basis screen (HBS), which is a concept that fuses core developments in holographic digital printing and holographic optical storage. The basic concept of creating a HBS is outlined in FIG. 2A. Specifically, FIG. 2A depicts the exposure process for a Hogel basis screen in accordance with an illustrative embodiment. FIG. 2B depicts the recording process for the Hogel basis screen in accordance with an illustrative embodiment.

The Hogel basis screen of FIGS. 2A and 2B includes an SLM/LCD 200, an objective 205, a mechanical stepper 210, and a Hogel basis screen (or holographic film) 215. Alternatively, fewer, additional, and/or different components may be included. In an illustrative embodiment, the SLM/LCD 200 can include a programmable SLM with few degrees of freedom. Alternatively, other SLM(s) may be used. In FIG. 2A, one Hogel is exposed at each instance, and the Hogels are exposed sequentially as the mechanical stepper 210 exposes different spatial regions on the holographic film 215. The Hogel exposure results in an interference pattern produced by an object wave 220 that is modulated by the SLM/LCD 200, and a reference beam 225 is recorded on a thick photosensitive emulsion. As shown in FIG. 2B, the recording process for the Hogel basis screen is similar to what is used for optical holographic storage. A set of holograms are recorded on the same area of the film. Each hologram includes the interference pattern of a different tilted plane wave reference, and a different object wave, produced by changing the image displayed on the SLM/LCD 200.

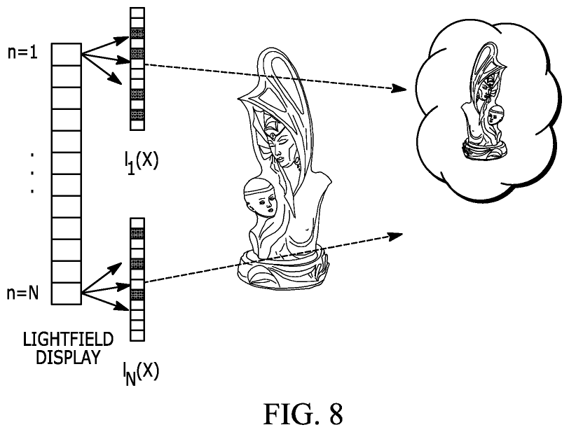

In operation, a light field l(x, u) is emitted from a display surface, where the 2D lateral coordinates on the display surface are x=(x, y), and the coordinates u=(u, v) are the tangents of ray angles emitted from the surface. The light field is discretized into n∈[1, . . . , N] spatial regions (Hogels) on the display surface, so that the set of rays emitted from the n^{th} spatial location can be represented on the display as lₙ(u) (see FIG. 8, described below). If the light field is generated by a coherent field ∈ₙ(u) with wavelength λ, ray directions are coupled to the spatial frequencies so that the spatial distribution of the field emitted from a hogel lₙ(x)=| [symbol] ⁻¹{εₙ(u\λ}|², where [symbol] {·} is the 2D Fourier Transform.

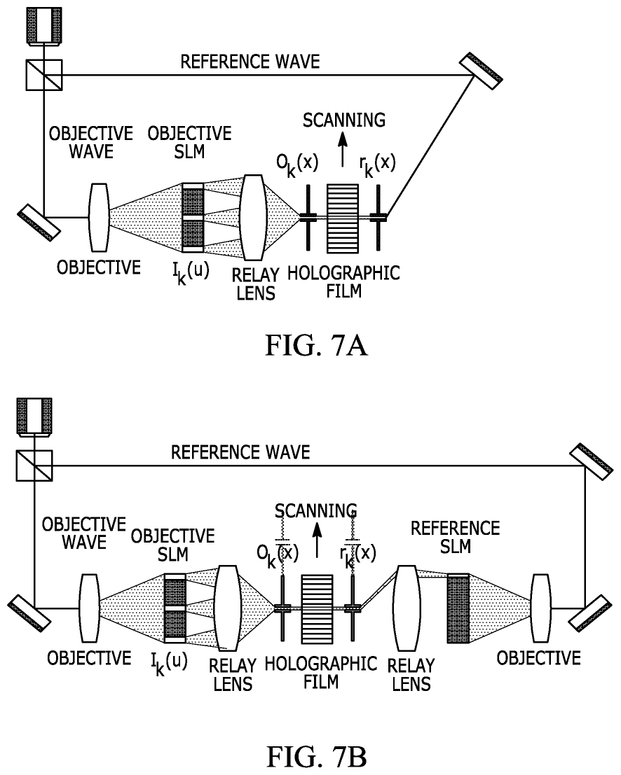

The basic concept of creating an HBS is outlined in FIG. 7B below. Specifically, a photosensitive emulsion records a set of interference patterns produced by a plane wave reference beam rₖ(x)≈exp (iØₖx) and an object SLM (O-SLM) wave oₖ(x)≈D[Iₖ(u)]. Here, x represents the 2D lateral field coordinates within a given hogel, Øₖ denotes the 2D direction cosine of the incident reference beam, Iₖ(·) represents the spatially varying 2D pattern displayed on the O-SLM (which can be complex if phase modulation is used), and [symbol] [·] is the free-space optical propagator over a distance from the O-SLM to the film surface (for the setup in FIG. 7B, [symbol] is a scaled Fourier Transform). An aperture is placed in front of the holographic film so that exposure is limited to a finite area on the film surface (e.g. 1 mm×1 mm). A sequence of k∈[1, . . . , K] holograms is recorded sequentially on the film, and the process is repeated as a stepper motor translates the film across n∈[1, . . . , N] different Hogel locations. The total 3D exposure within the volume holographic film for the n^{th} Hogel is:

Eₙ(x,z)∝Σₖ₌₁^{K}|Q_{z}[rₖ(x)+ [symbol] [Iₖ(u)]]|², Eq. 1:

where Q_{z} represents the 3D propagator inside the film (e.g., Huygen's propagator). After the set of K exposures are performed for each of the N Hogel locations, the holographic screen produces a 3D phase modulation function [symbol] ₙ(x, z)∝Eₙ(x, z) proportional to its exposure. Provided that the hologram thickness d is sufficiently large so that the Bragg condition successfully filters out holograms captured with reference beams separated by an angle ΔØ≈λ/d, then each of the recorded images may be reproduced independently by illuminating the hologram with the corresponding reference beam:

[symbol]

[rₖ(x), [symbol] ₙ(x,z)∝ [symbol] [Iₖ(u)], Eq. 2:

where [symbol] [r, [symbol] ] represents the function that propagates the incident field r through the phase modulation function [symbol] recorded inside the volume hologram. Equation 2 expresses that the light field emitted from a reference beam incident on the n^{th} Hogel with incident angle Øₖ is proportional to the k^{th} image displayed on the O-SLM and recorded on the hologram. More generally, if the n^{th} Hogel is illuminated with a weighted combination of reference beams, the total incident field on the n^{th} Hogel is:

rₙ(x)=Σₖ₌₁^{K}α_{n,k}·rₖ(x). Eq. 3:

In equation 3, α_{n,k}² represents the intensity of the ray incident on the n^{th} Hogel location from the k^{th} illumination direction, and α_{n,k} therefore represents a low-resolution (LR) lightfield. The intensity of the rays exiting the hogel is a linear combination of the images displayed on the O-SLM during Hogel recording, as shown in FIG. 7B.

lₙ(x)=|Σₖ₌₁^{K}α_{n,k}· [symbol] [rₖ(x), [symbol] ₙ(x,z)]|²=|Σₖ₌₁^{K}α_{n,k}· [symbol] [Iₖ(u)]|². Eq. 4:

It can be assumed that there is a discretization of spatial coordinates relative to the M pixels on the O-SLM, corresponding to M different ray angles exiting each Hogel surface so that [symbol] [Iₖ(u)]→hₖ∈ [symbol] ^{M}. The discretized form of Eqn. 4 then becomes:

lₙ=|Σₖ₌₁^{K}α_{n,k}·hₖ|²=| [symbol] αₙ|², Eq. 5:

where αₙ∈ [symbol] ₊^{K} represents the set of rays incident on the n^{th} Hogel, lₙ∈ [symbol] ₊^{M} represents the set of rays exiting the n^{th} Hogel, [symbol] ∈ [symbol] ^{M×K} is the Hogel basis encoded in the volume hologram, and the |·| operator is taken elementwise. When the identical Hogel basis is recorded at each position on the film, it can be expressed as:

[symbol]

=| [symbol] |², Eq. 6:

where [symbol] ∈ [symbol] ₊^{K×N} is a matrix representing the incident LR light field consisting of N spatial samples and only K ray samples, and [symbol] ∈ [symbol] ₊^{M×N} represents the emitted 4D light field with M>>K ray samples for each spatial location. Equations 4-6 express the fundamental principle of the Hogel basis 3D display, namely that the set of rays diffracted from each Hogel are a linear combination of the K images displayed on the O-SLM during Hogel recording. In particular, when M>>K, the SBP for the display is significantly increased. This is because a HR light field is recorded as a fixed pattern in the volume holographic film. The HBS has a very large SBP=M·N≈10⁸-10⁹. To display a 3D image, a LR light field that includes a set of rays with intensities [symbol] ∈ [symbol] ₊^{K×N} is projected onto the HBS. The incident light field has a very small SBP=K·N≈10⁶. However, the light field emitted from the HBS has an SBP equal to the HBS, and produces a scattered intensity that closely matches the ground truth HR light field [symbol] ∈ [symbol] ₊^{M×N}. The key to utilizing this principle lays in the careful selection of an appropriate Hogel basis [symbol] such that a large variety of naturally occurring, HR light fields may be reconstructed using only K degrees of freedom per Hogel.

The forward model expressed by Equation 6 represents a factorization of the light field scattering from a Hogel basis screen. The degree to which a light field may be accurately approximated with this factorization will be determined by how well Equation 6 matches with the ground truth ray intensities of a large set of naturally occurring HR light fields. In particular, one may have access to a large database of P naturally occurring HR light fields [symbol] ^{p}∈ [symbol] ₊^{M×N}, p∈[1, . . . , P]. Then, the problem of learning the optimal Hogel basis [symbol] boils down to solving the minimization problem:

$$, {p}^{} = {argmin}_{ℋ , {𝒜}^{p}} {\sum }_{p = 1}^{P} ℰ ( {ℒ}^{p} - {\vert {ℋ𝒜}^{p} \vert}^{2} ) + ( {𝒜}^{p} ) , \qquad Eq . 7$$

where ε(·) represents the loss function which ensures fidelity of the basis representation relative to the training data [symbol] ^{p}, and [symbol] (·) represents a regularization function on the basis coefficients. For instance, setting [symbol] (·)=|·|², [symbol] (·)=|·|₁, is a coupled sparse dictionary learning (e.g., KSVD) and phase-retrieval problem. The solution to the optimization problem expressed by Equation 7 produces a fixed Hogel basis [symbol] that can be used to represent any light field [symbol] in terms of the learned basis coefficients [symbol] . Solutions to other variants of loss functions may be found using other methods, for instance using Deep Neural Networks (DNNs) that are trained using stochastic gradient descent.

In addition to building prototypes of the system, development of the proposed system also includes development of optimization algorithms to learn an optimal Hogel basis from a database of high resolution light fields. The light fields can be generated synthetically using one or more physically-based open source 3D computer graphics rendering packages, such as Blender, PBRT, Mitsuba, etc. Though the synthesized light fields do not exactly mimic high resolution captured light fields, they do exhibit a very high degree of similarity. In particular, the physically based renderers include subtle light transport effects such as soft shadows, sub-surface scattering, spatially varying bidirectional reflectance distribution function(s) (BRDF), etc.

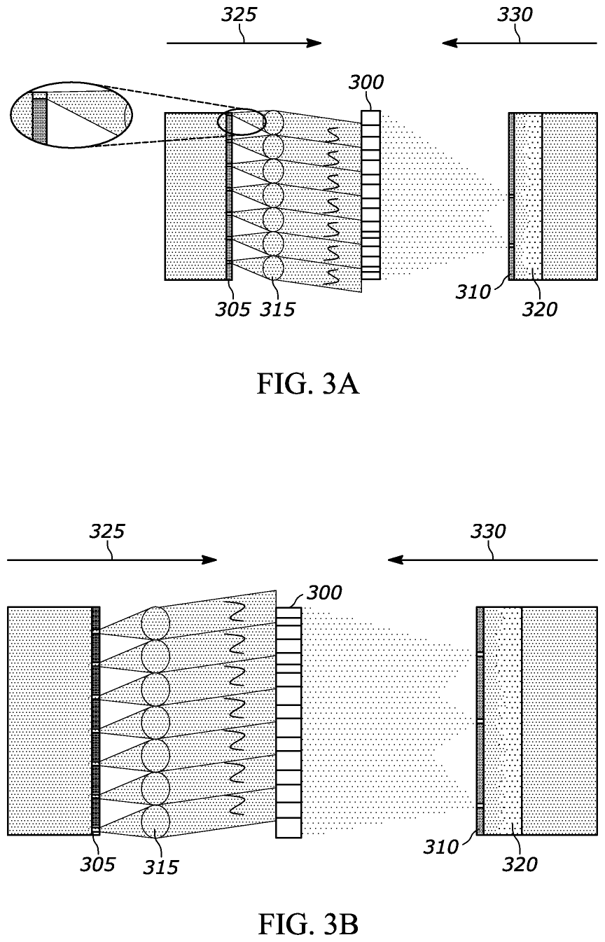

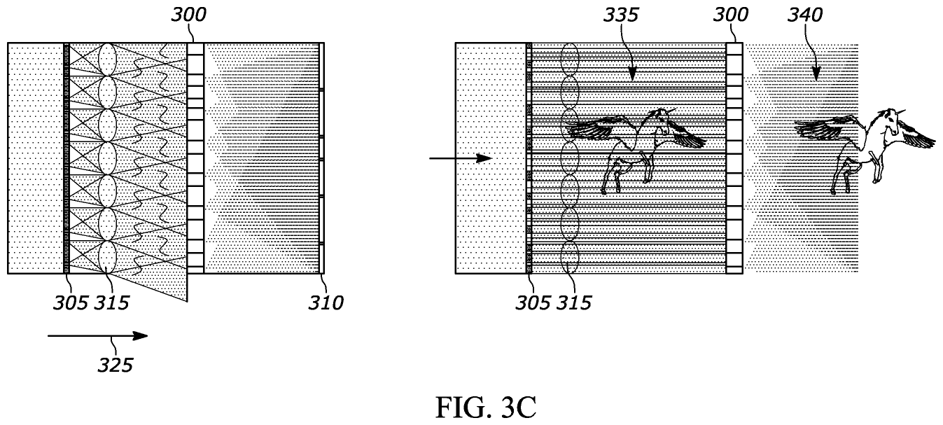

In an illustrative embodiment, the prototype system depicted in FIGS. 3A-3D can be used to generate the holograms described herein. FIG. 3A depicts a first recording process for a 3D display system with a Hogel basis screen in accordance with an illustrative embodiment. FIG. 3B depicts a second recording process for the 3D display system with the Hogel basis screen in accordance with an illustrative embodiment. The system includes a Hogel basis screen 300, a reference wave LCD/SLM 305, an object wave LCD/SLM 310, a microlens array 315, and a diffuser 320. In alternative embodiments, fewer, additional, and/or different components may be used. A reference wave 325 is incident on the Hogel basis screen 300 from the left and an object wave 330 is incident on the Hogel basis screen 300 from the right. The 3D display system allows for multiple Hogels to be exposed simultaneously. FIGS. 3A and 3B depict the exposure process for the Hogel Basis Screen (HBS), after which the HBS is developed, and the fringe pattern is encoded into the hologram. FIG. 3C depicts a playback process for the 3D display system with the Hogel basis screen in accordance with an illustrative embodiment. More specifically, FIG. 3C depicts reconstruction of two different light fields from a developed HBS (e.g., the embodiment of FIG. 3A). The first light field is a low resolution light field 335, and the second light field is a high resolution light field 340.

The 3D display system of FIG. 3 allows for multiple Hogels to be exposed simultaneously. Each exposure is produced by displaying a grid of pixels on the reference wave LCD/SLM 305 with the same spacing as the microlens array 315. This produces an approximately collimated reference wavefront incident on the photosensitive film. The object wave LCD/SLM 310 displays one of the angular spectrum bases, and the interference between the reference LCD/SLM 305 and the object LCD/SLM 310 is recorded on the photosensitive screen, as shown in FIG. 3B. The image on the reference LCD/SLM 305 is shifted so that the reference beam angle changes. At the same time a new image is displayed on the object LCD/SLM 310. The interference pattern is recorded onto the photosensitive screen and the process is repeated for K different exposures, as shown in the left-hand portion of FIG. 3C.

For playback, the Hogel basis screen is photo-developed, the object LCD/SLM 310 is removed, and an image is programmed on the reference LCD/SLM 305. When just two pixels are turned on the object LCD/SLM 310, each pixel produces a ray that activates a different Hogel, each of which reproduces a different object LCD/SLM image Iₖ∈ [symbol] ^{M}, depending on the angle kΔϕ incident to the Hogel screen (as shown in the right-hand portion of FIG. 3C). When all pixels on the reference LCD/SLM 305 are used, a total of K different rays are incident on each hogel, producing a close approximation to a high resolution light field that includes the Hogels lₙ∈ [symbol] ^{M}.

In some embodiments, the display format of the proposed system may cover the learning and recording of a fixed angular spectrum basis for the purpose of synthesizing dynamic 3D images with exceedingly large SBP, while using a single, low resolution, programmable SLM. In alternative embodiments, different techniques and/or hardware may be used. For example, in one embodiment, multiple SLMs can be used in the system to increase the fidelity of projected 3D display imagery over larger display sizes. Additionally, Hogel basis screens can be manufactured over much larger areas using a step-and-repeat approach (e.g., similar to the approach used in digital holographic printing).

In some embodiments, the system can be based on learning a fixed 2D angular spectrum basis. However, the concept can also be generalized to consider a full, spatial-angular 4D light field basis. Such an approach enables increased fidelity in 3D display quality with fewer degrees of freedom, but would come at the cost of increased complexity in Hogel basis screen recording, integrated display components (e.g. more SLMs), or both. Additionally, the principles described herein can be used to generate high resolution compressive 2D display content and/or other possible extensions such as a high fidelity 4D reflectance display, a high fidelity 8D reflectance display, etc.

In an illustrative embodiment, the same concept used to convert a low resolution light field into a high resolution light field using the high SBP Hogel basis screen can also be used in reverse. For example, the LCD/SLM used in the playback of FIG. 3C can be replaced with a focal plane array sensor, and a real object can be positioned in front of the FIBS screen. A high resolution light field can be recorded directly in the form of a 2D image, where the pixel intensities represent the coefficients in the fixed Hogel basis pre-recorded on the screen. The captured 2D image can then be used to either synthesize a high resolution light field, or it may be used to transmit a compressed low resolution light field through a real-time holographic video communication system capable of real-time, high fidelity 3D image capture, transmission, and display.

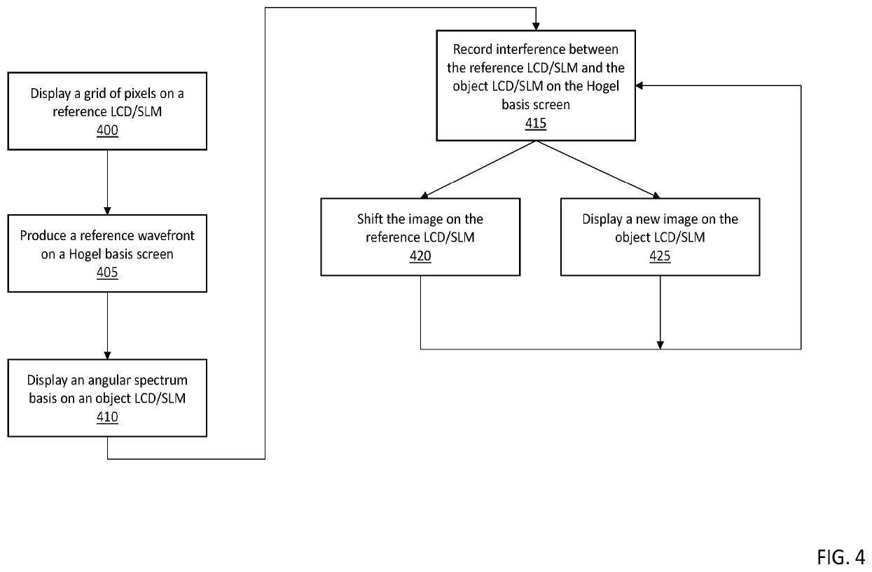

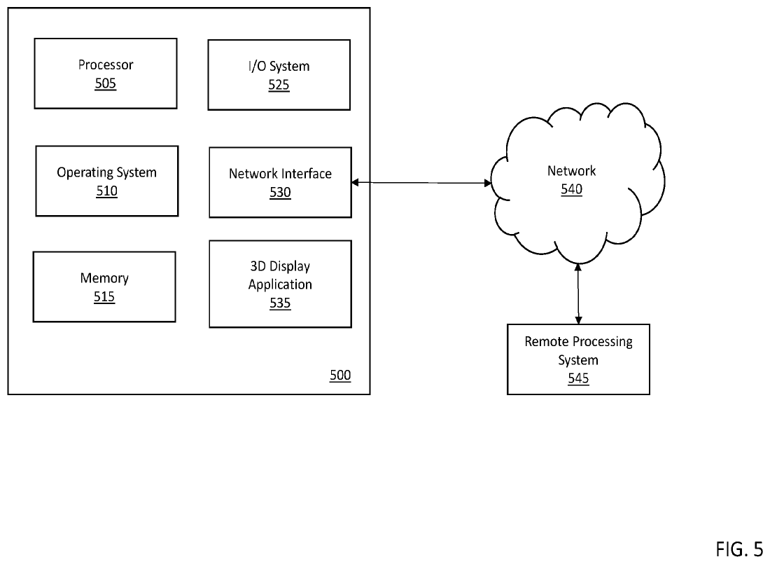

FIG. 4 is a flow diagram depicting a recording process for a 3D display system in accordance with an illustrative embodiment. In alternative embodiments, fewer, additional, and/or different operations may be performed. Also, the use of a flow diagram is not meant to be limiting with respect to the order of operations performed. In an operation 400, a grid of pixels is displayed on a reference LCD/SLM. The grid of pixels can be displayed to match spacing of a microlens array that is positioned between the reference LCD/SLM and the Hogel basis screen. In an operation 405, a reference wavefront is produced on the Hogel basis screen. In an illustrative embodiment, the reference wavefront is an approximately collimated wavefront that is generated in response to the grid of pixels displayed on the reference LCD/SLM.

In an operation 410, an angular spectrum basis is displayed on an object LCD/SLM. The angular spectrum basis can result in an object wavefront. In an operation 415, interference between the reference LCD/SLM and the object LCD/SLM is recorded on the Hogel basis screen. In an operation 420, the image on the reference LCD/SLM is shifted so that the reference beam angle changes. In an operation 425, a new image is displayed on the object LCD/SLM. In an illustrative embodiment, the operations 420 and 425 can occur simultaneously (or nearly simultaneously). The interference pattern between the reference LCD/SLM and the object LCD/SLM is again recorded on the Hogel basis screen in the operation 415. In an illustrative embodiment, the operations 415, 420, and 425 continue to repeat a plurality of times until the desired number (K) of difference exposures is reached for each Hogel.

FIG. 5 is a block diagram of a computing system 500 for a 3D display system in accordance with an illustrative embodiment. The computing system 500 includes a processor 505, an operating system 510, a memory 515, an I/O system 525, a network interface 530, and a 3D display application 535. In alternative embodiments, the computing system 500 may include fewer, additional, and/or different components. The components of the computing system 500 communicate with one another via one or more buses or any other interconnect system. In an illustrative embodiment, the computing system 500 can be part of a laptop computer, desktop computer, display, etc.

The processor 505 can be any type of computer processor known in the art, and can include a plurality of processors and/or a plurality of processing cores. The processor 505 can include a controller, a microcontroller, an audio processor, a graphics processing unit, a hardware accelerator, a digital signal processor, etc. Additionally, the processor 505 may be implemented as a complex instruction set computer processor, a reduced instruction set computer processor, an x86 instruction set computer processor, etc. The processor 505 is used to run the operating system 510, which can be any type of operating system.

The operating system 510 is stored in the memory 515, which is also used to store programs, network and communications data, peripheral component data, light field information, the 3D display application 535, and other operating instructions. The memory 515 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 525 is the framework which enables users and peripheral devices to interact with the computing system 500. The I/O system 525 can include a mouse, a keyboard, one or more displays, a speaker, a microphone, etc. that allow the user to interact with and control the computing system 500. The I/O system 525 also includes circuitry and a bus structure to interface with peripheral computing devices such as power sources, USB devices, peripheral component interconnect express (PCIe) devices, serial advanced technology attachment (SATA) devices, high definition multimedia interface (HDMI) devices, proprietary connection devices, etc. In an illustrative embodiment, the I/O system 525 is configured to receive inputs and operating instructions from a user.

The network interface 530 includes transceiver circuitry that allows the computing system to transmit and receive data to/from other devices such as remote computing systems, servers, websites, etc. The network interface 530 enables communication through the network 540, which can be in the form of one or more communication networks and devices. For example, the network 540 can include a cable network, a fiber network, a cellular network, a wi-fi network, a landline telephone network, a microwave network, a satellite network, etc. and any devices/programs accessible through such networks. The network interface 530 also includes circuitry to allow device-to-device communication such as Bluetooth® communication.

The 3D display application 535 includes hardware and/or software, and is configured to perform any of the operations described herein. Software of the 3D display application 535 can be stored in the memory 515. As an example, the 3D display application 535 can include computer-readable instructions to control the reference LCD/SLM and/or the reference wave, control the object LCD/SLM and/or the object wave, control movement of the mechanical stepper, control exposure of Hogels on the Hogel basis display, control playback of 3D imagery, identify optimal basis, etc.

The computing system 500 is in communication with a remote processing system 545 via the network 540. In an illustrative embodiment, the remote processing system 545 can be used to perform any of the processing operations described herein. In some embodiments, the remote processing system 545 can house some or all of the 3D display application 535. In an alternative embodiment, the remote processing system 545 may not be used.

### EXAMPLES

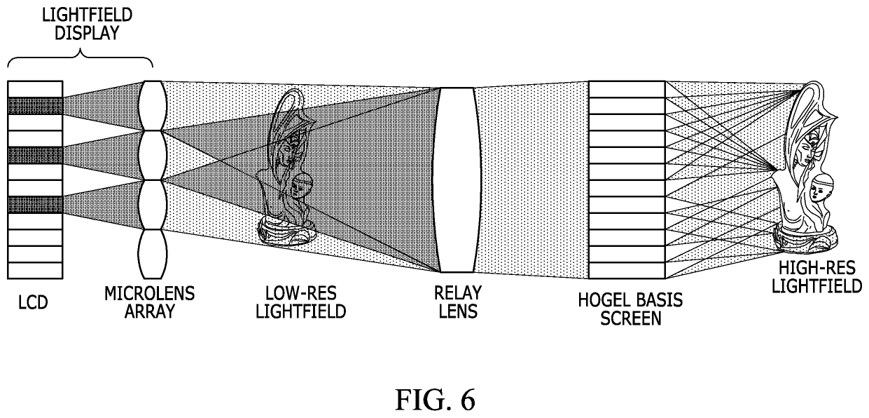

As discussed herein, the proposed methods and systems utilize established optical recording techniques to produce 3D displays with unprecedented realism, and that can be programmed using only low-resolution SLM technology. The technical approach to achieve such systems was to use data-driven techniques to learn a representation of the set of physically plausible light fields using only the 10⁶ programmable rays offered by a single commercially available SLM. The core idea is outlined in FIG. 6 below.

FIG. 6 depicts a data-driven 3D display system in accordance with another illustrative embodiment. In FIG. 6, a low resolution (LR) light field is generated from an LCD with a microlens array positioned in front of it. The number of pixels on the LCD limits the number of programmable rays to about 10⁶. The LR light field is projected onto a Hogel Basis Screen (HBS). In an illustrative embodiment, the FIBS is a 10 cm×10 cm screen onto which is recorded a fixed holographic basis with SBP on the order 10⁸-10⁹ rays. Alternatively, a different size of HBS may be used. The recorded Hogel basis is learned from a training database that includes naturally occurring light fields. As shown, a bust is programmed on the LCD, and the HBS is used to generate a high resolution (HR) light field that portrays a 3D visualization of the bust. Dynamic HR 3D imagery can also be displayed by programming the appropriate sequence of images onto the LCD. In alternative embodiments, objects/people other than busts can be represented, such as landscapes, buildings, flowers, landmarks, etc.

FIG. 7A depicts a digital holographic printer system in accordance with an illustrative embodiment. FIG. 7B depicts a multiplexed digital holographic printer system in accordance with an illustrative embodiment. In FIG. 7A, the exposure process for the digital holographic printer is shown. One Hogel is exposed at each spatial location, and the Hogels are exposed sequentially as a mechanical stepper exposes different spatial regions on the film. The Hogel exposure is based on an interference pattern produced by an object wave that is modulated by an SLM, and a reference beam, recorded on a thick photosensitive emulsion. In the embodiment, of FIG. 7B, the recording process for the Hogel basis screen is shown. The recording process is similar to what is used for optical holographic storage. A set of K holograms are recorded at each spatial location on the film. Each hologram is based on the interference pattern between a tilted plane wave reference rₖ(x) produced by the image displayed on the R-SLM, and object wave oₖ(x) produced from the image Iₖ(u) displayed on the O-SLM. A sequence of k∈[1, . . . , K] exposures is made before a translation stage moves the film to expose the next Hogel on the HBS.

FIG. 8 depicts geometry of a light field display in accordance with an illustrative embodiment. As shown, the displayed light field is discretized into a grid of N spatial locations. At each spatial location, a set of rays lₙ(x) is emitted. The intensity of each ray is determined by intersecting with a 3D model and determining the reflectance in this viewing direction.

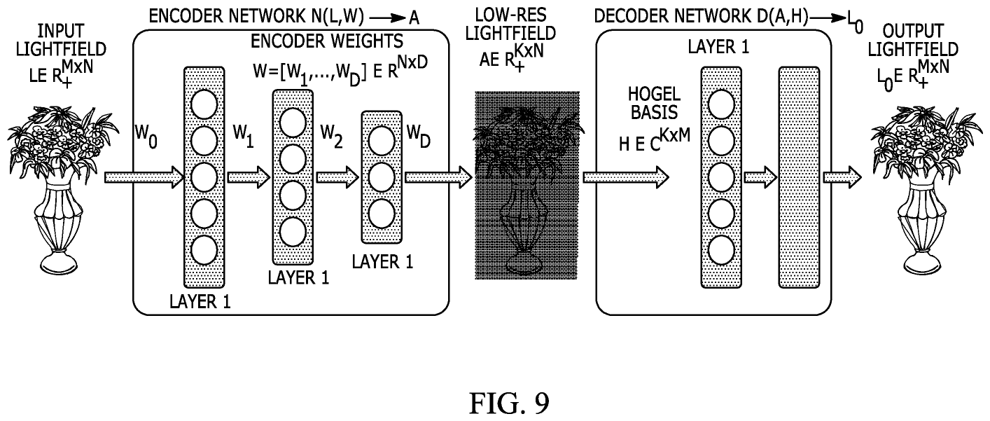

FIG. 9 shows an autoencoder DNN architecture (HBS-NN) that incorporates the physical constraints of optical propagation through the HBS volume hologram in accordance with an illustrative embodiment. The HBS-NN includes an encoder [symbol] ( [symbol] , [symbol] )→ [symbol] with [symbol] layers of network weights [symbol] ∈ [symbol] ^{N×D} and activation units that map a HR lightfield [symbol] down to a small set of features [symbol] that encode the light field in a low dimensional space. The decoder [symbol] ( [symbol] , [symbol] )→ [symbol] ₒ includes a single layer representing a transformation by the Hogel basis [symbol] , followed by a squaring operation. Optimization of the HBS-NN can be interpreted according to Equation 7 by defining the data fidelity term as ε[ [symbol] ^{p}− [symbol] ( [symbol] ( [symbol] ^{p} [symbol] ), [symbol] )], and recognizing the implicit regularization of the encoder network as [symbol] ( [symbol] ^{p})≈ε[ [symbol] ^{p}− [symbol] ( [symbol] ^{p}, [symbol] )]. Training the network with example HR light fields simultaneously learns an optimal set of encoder weights [symbol] , and determines the optimal Hogel Basis [symbol] to record on the holographic film. After training, an HR light field [symbol] ^{p} may be efficiently transformed into a set of optimal Hogel basis coefficients by simply feeding forward through the trained encoder network [symbol] ^{p}= [symbol] ( [symbol] ^{p}, [symbol] ).

The HBS-DNN algorithm illustrated in FIG. 9 uses the Hogel basis [symbol] as a proxy for the information encoded in the HBS volume hologram. However, the information encoded in the hologram can be more precisely modeled using Equations 1-2, which relate the light field incident on the HBS l(x), the 3D exposure pattern recorded in the film [symbol] (x, z), and the light field emitted from the HBS lₒ(x)= [symbol] [l(x), [symbol] (x, z)]. A more accurate optimization process is to learn the optimal exposure pattern [symbol] (x, z) directly from the HR training samples [symbol] ^{p}. Unfortunately, this process is complicated by the difficulty in efficiently implementing a differentiable optical propagation operator [symbol] [·]. However, it has been shown that a beam propagation operator can be implemented as a convolutional neural network (CNN). It is therefore proposed to develop a beam propagation CNN (BP-CNN) [symbol] ( [symbol] , [symbol] )→ [symbol] ₒ that is differentiable and can be easily incorporated into the HBS-NN optimization framework illustrated in FIG. 9. This is a high-risk/reward approach. Incorporation of such strong physical constraints will help develop more efficient low-dimensional embeddings. However, this comes at the cost of discretizing the 3D exposure pattern, which will increase training time and storage requirements.

In one embodiment, a megapixel SLM is used to create a low resolution (LR) light field. The LR light field is projected onto a Hogel Basis Screen (HBS). The HBS has recorded a fixed basis, producing high resolution (HR) light field imagery with unprecedented 3D realism. The basis recorded on the HBS is fixed in one embodiment, and dynamic content can be displayed by modifying the image on the SLM. The displays can be single color (wavelength) or full color, depending on the implementation.

Another embodiment is directed to a single Hogel 2D display that uses multiplexed volume holography. The hardware and software of such a system can be developed to test and expand upon the basic principles of the 3D display concept (in 2D). In such an implementation, a volume hologram that includes a single holographic pixel, or Hogel, is used to multiplex numerous 2D basis images onto an approximately 1 mm×1 mm area on a photopolymer photographic film. The basis images are learned from a dataset of example 2D images, then recorded onto the volume holographic film by interfering with a reference beam. After the hologram is developed, a high-resolution 2D image is reconstructed using a low-resolution SLM coupled with the recorded volume hologram.

Development of a single Hogel 2D display involves development of a rendering framework to model the physical propagation of light through volume diffraction gratings. The framework has two important uses for the overall program. First, it can be used to verify theoretical relationships between a volume hologram, the maximum number of multiplexed holograms that can be stored, and the diffraction efficiency of each hologram. Formally, Equation 1 can be numerically implemented, which allows for calculation of the phase modulation function [symbol] (x,z) produced from a set of holographic exposures. The function [symbol] [rₖ(x), [symbol] ₙ(x, z) from Eqn. (2) can also be numerically implemented, which propagates the input field r(x) through the phase modulation function [symbol] (x, z) recorded inside the volume hologram. Accurate numerical calculation of [symbol] [·] involves a suitable choice of optical propagation models. Candidate propagation models include Huygens/ASM propagation, Beam propagation, Coupled Wave Theory (CWT), Finite Difference Time Domain methods, etc. Second, the output of the optical propagator can be used to compute the predicted Hogel basis [symbol] for a given recorded exposure pattern [symbol] (x, z). Once an accurate estimate of the Hogel basis is determined, it is possible to decompose an HR light field [symbol] into an LR lightfield [symbol] using Equation 6, and determine the HR lightfield produced when the LR lightfield is incident on the HBS using the forward model in Equation 5. The rendering framework enables end-to-end simulation of 3D lightfields produced by the 3D display prototypes described herein.

A system can also be developed to multiplex multiple images into a photopolymer volumetric hologram using a transmission geometry. FIG. 7B depicts the exposure process for the prototype Holographic basis screen. The experimental setup is a combination of a digital holographic printer (e.g., FIG. 7A) and a holographic optical storage device. In some test embodiments, only a single Hogel will be printed so that no mechanical scanning is involved. For photopolymer film, Colestra BayfolHX photopolymer (d=16 μm thick, maximum index contrast Δn=0.1). To record the hologram, the coherent field diffracted from a phase-based SLM (Holoeye Pluto, 8 um pixel size) can be demagnified ⅛× onto the holographic film, producing a reference beam with maximum fringe period of Λ=2 μm over an approximately 1 mm×1 mm area. The R-SLM beam will be interfered with an object beam diffracted from a separate SLM with the same or similar dimensions and pixel size, also demagnified ⅛× onto the photopolymer film. The O-SLM and R-SLM beams are combined with a beam splitter, producing a reflection style volume hologram. The theoretical maximum number of holograms that can be recorded is X=(d/Λ)²≈64. Thicker holographic film and larger demagnification ratios can also be used to increase the maximum number of multiplexed holograms.

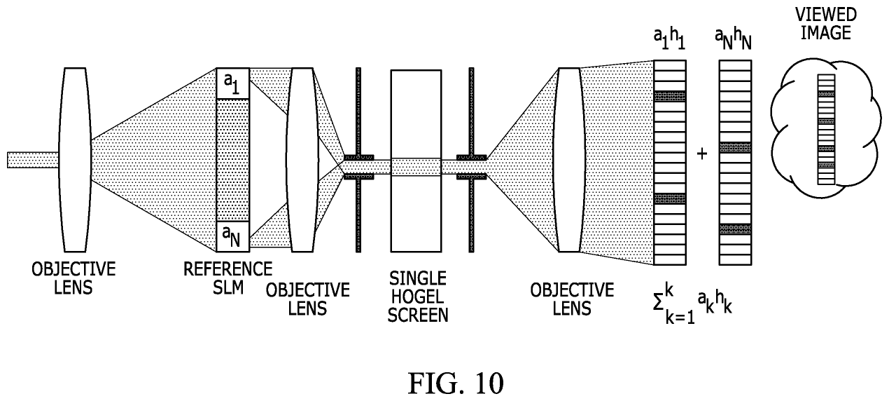

After being exposed, the developed hologram can be used as a Holographic basis screen (HBS) to display high resolution 2D imagery. The principle of operation for the single hogel 2D display is illustrated in FIG. 10. Specifically, FIG. 10 depicts a 2D display prototype in accordance with an illustrative embodiment. A LR 2D image α= [symbol] ^{K} can be displayed on the R-SLM. The display will output a linear combination of Hogel basis images Σₖ₌₁^{K}αₖhₖ∈ [symbol] ₊^{M}, where M>>K, so that 2D resolution is increased. The results of playing back the hologram can be recorded onto a CMOS camera to analyze the contrast, resolution, and diffraction efficiency of recorded HBS as a function of the amount of hologram multiplexing (i.e., the number of Hogel bases).

Another embodiment is directed to a dynamic compressive 3D display using a Hogel Basis Screen. In one implementation, the above-referenced single Hogel 2D display can be extended to form a fully-functioning multiplexed digital holographic printer, which can then be used to manufacture a Hogel Basis Screen (HBS). A step-and-repeat process can be used to record a 2D grid of Hogels onto a 10 cm×10 cm HBS. The printed HBS will be coupled with a SLM producing a LR light field of approximately 10⁶ rays. After exiting the HBS, a HR lightfield will be produced with 10⁸-10⁹ rays, enabling dynamic 3D content with significantly greater 3D realism.

To implement the dynamic compressive 3D display, algorithms are developed to learn an optimal Hogel basis from a database of high-resolution light fields and to reconstruct HR light fields from their respective Hogel basis coefficients (LR light field). New HBS-DNN auto-encoder optimization algorithms can also be developed for learning Hogel Basis [symbol] , and estimating Hogel Basis coefficients [symbol] from an HR lightfield [symbol] . The network architecture can encode physical propagators in the form of network weights in the decoder network [symbol] ( [symbol] , [symbol] )→ [symbol] ₒ. The optimized weights in the decoder after training correspond to the learned Hogel Basis [symbol] , which is printed onto the HBS screen. The HBS-DNN is also used to optimize a set of weights [symbol] for an autoencoder. For the testing phase of the LS-NN, a target HR light field [symbol] is input feed-forward into the trained encoder and the coefficients [symbol] = [symbol] ( [symbol] , [symbol] ) are computed. As illustrated in FIG. 6, these coefficients are displayed on the R-SLM, so that the field emitted from the FIBS closely resembles the original HR-lightfield [symbol] . The training set of light fields are generated synthetically using a physically-based open source 3D computer graphics rendering packages such as Blender, PBRT, Mitsuba, etc. The synthesized HR light fields will exhibit a very high degree of similarity to physically captured HR light fields. In particular, physically based renderers used will include subtle light transport effects such as soft shadows, sub-surface scattering, spatially varying BRDF, etc.

To construct the 3D display, a fully functioning multiplexed digital holographic printer can be constructed in one embodiment (as illustrated in FIG. 7B). The single hogel multiplexed printer described above can be extended to include mechanical scanning over a 100×100 grid of 1 mm×1 mm Hogels, producing a Hogel basis screen with an area of 10 cm×10 cm. An identical Hogel basis [symbol] is recorded at each grid location. A high-power laser (e.g., Cobolt Samba 1.5 W, 532 nm) can also be incorporated into the setup to reduce exposure times. It is anticipated that exposure times for each Hogel exposure will be on the order of a few seconds so that an entire HBS can be printed within 3 hours. A Colestra BayfolHX photopolymer can be used in some embodiments due to the simplicity in its development process. Photopolymer films can be used because they can be developed without a wet-lab. However, photopolymer films are 1-2 orders of magnitude less sensitive than silver-halide emulsions. To reduce exposure time, silver-halide holographic film may be used in some embodiments.

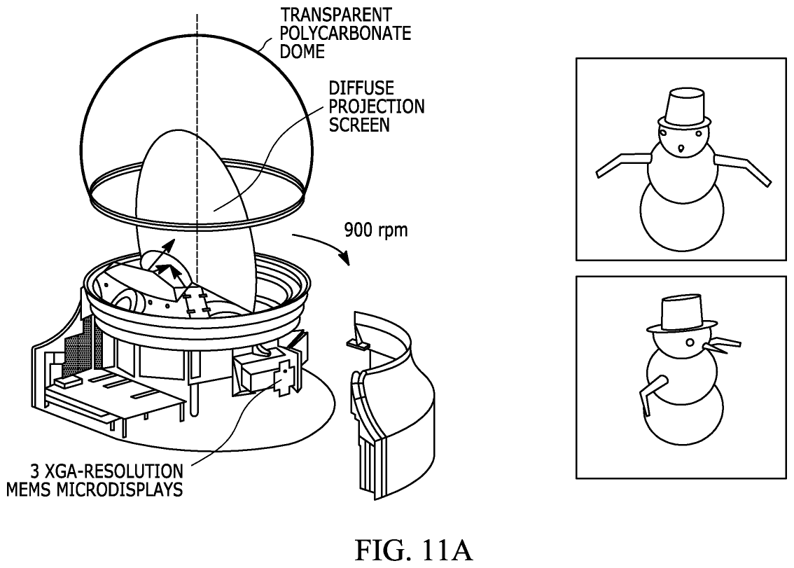

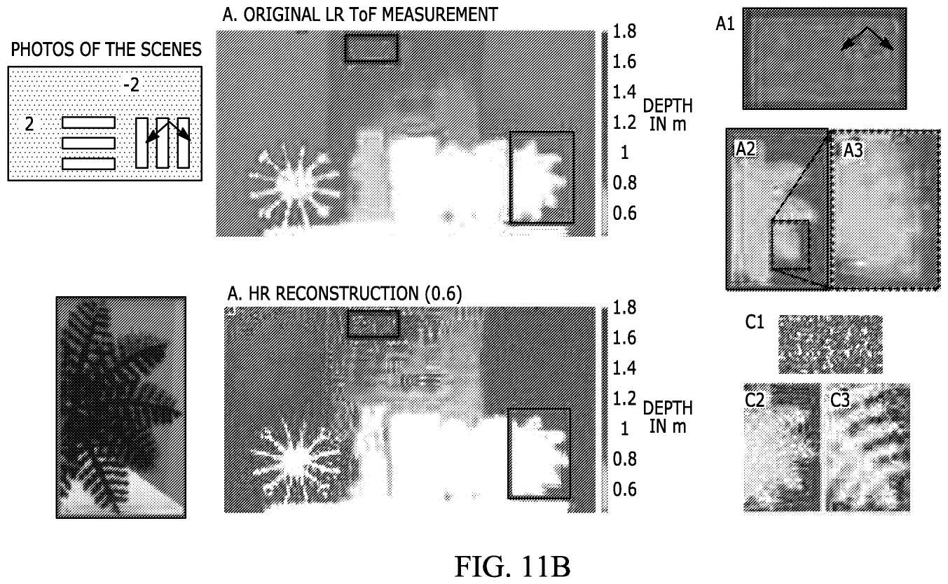

FIG. 11A illustrates the principle of playback for a FIBS 3D display in accordance with an illustrative embodiment. FIG. 11B illustrates compressed time-of-flight (ToF) 3D imaging in accordance with an illustrative embodiment. The design of FIG. 11A includes a rotating screen coupled with a fast DLP projector. Two views of a 3D snowman are presented on the display, demonstrating 3D motion parallax over a full 360 degree field of view. With respect to FIG. 11B, it can be seen that compressive ToF 3D imaging increases the spatial resolution of LR commercial ToF sensors. As shown at the top of FIG. 11B, a conventional ToF sensor is too low resolution to capture fine details in the scene. The insets of FIG. 11B show that much higher resolution detail in the 3D depth map can be recovered in the plastic toy plant and resolution target using the proposed compressive super resolution hardware and software.

Still referring to FIG. 11A, the LR light field display is created from a LCD coupled with a lens array. In some embodiments, an 20 cm×10 cm, 1920×1080 pixel LCD display with pixel size≈100 μm can be used. The LCD is coupled with a 152×152 lens array, with 1 mm lenslet size (e.g., FresnelTech #630), which is imaged onto the printed HBS using two coupled Schneider relay lenses (e.g., Edmund Optics #59-830). This allows as many as K=100 incident rays per Hogel to be multiplexed. The prototype HBS 3D display can be used to demonstrate free-floating, high-resolution 3D images for a small collection of light fields selected for testing from the FIBS training database. The light fields can be photographed from a set of predefined viewing conditions and qualitative comparisons made to ground truth HR light fields. A series of resolution tests (e.g., using USAF resolution targets) can also be conducted to quantify the 3D resolution capabilities of the 3D display device. Additionally, dynamic 3D content from light field animations generated from open-source physically-based rendering and animation software (e.g., Blender) can be demonstrated using the system.

Another embodiment is directed to a programmable 3D reflectance field display. Typically, the illumination of 2D/3D imagery is presented with illumination that is determined at the time of capture. Reflectance displays capture the response of 2D/3D scenes to different incoming lighting directions, so the visual display can be made consistent with environmental illumination conditions. In one implementation, the aforementioned multiplexed digital holographic printer can be used to multiplex multiple holograms of a 3D object illuminated under different viewing directions onto a single piece of holographic film. The multiplexed hologram can be played back using environmental lighting, providing realistic illumination of 3D objects with visual cues that are highly consistent with the environment, including shading, shadows, caustics, and reflections.

To implement a system for digital holographic printing of 3D reflectance fields, a multiplexed digital holographic printer and associated software can be used for displaying dynamic 3D content with unprecedented realism. The printer can be used to manufacture an HBS, and 3D content is programmed by projecting different LR light fields onto the HBS. In this embodiment, the multiplexed digital printer is used to record a set of holograms with fixed 3D content and varying reflectance. First, a 3D reflectance field is generated by rendering or acquiring a HR light field of a 3D scene under all possible point source illuminations. From the set of rendered images, the scene can be computationally relit so as to produce realistic light-material interactions in a synthetic environment, which is a technique used in the visual effects industry to create renderings of real actors in computer generated environments. This 3D reflectance field can be used to demonstrate a programmable 3D reflectance field display. Typically, the illumination of 2D/3D imagery is presented with illumination that is determined at the time of capture. However, the proposed multiplexed digital holographic printer will allow one to record all HR light fields at once onto the holographic film, and then replay them in a linear combination so that the 3D field is computationally illuminated with the desired environmental lighting. The computational relighting process is identical to the FIBS display process and is illustrated in FIG. 9.

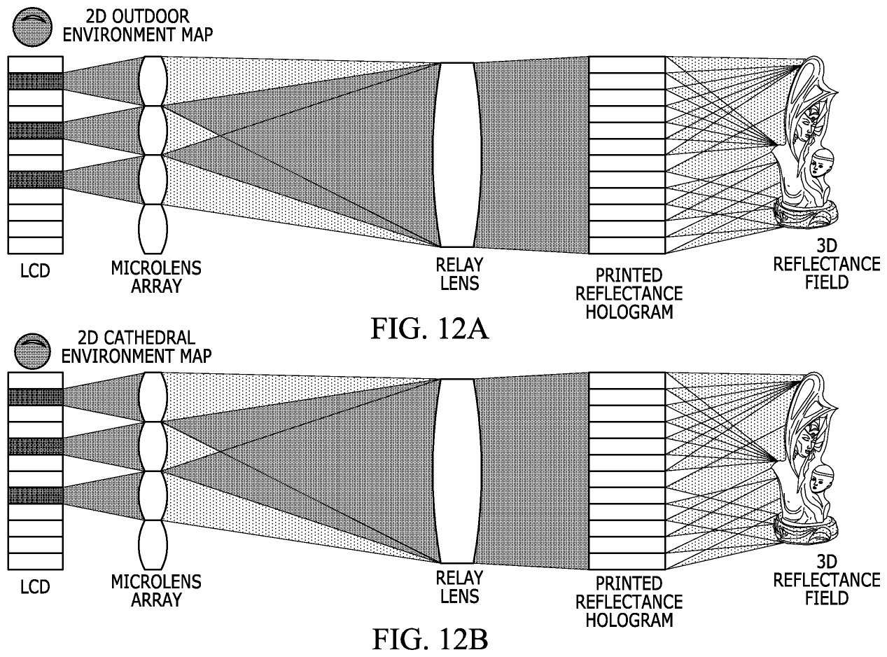

FIG. 12A depicts a programmable reflectance 3D display in accordance with a first illustrative embodiment. FIG. 12B depicts a programmable reflectance 3D display in accordance with a second illustrative embodiment. The display concept uses the above-described multiplexed digital holographic printer to record 3D reflectance fields onto a volume holographic film. In FIG. 12A, an LCD is programmed with the 2D environmental illumination map of an outdoor scene captured with a light probe. The resulting 3D image is illuminated by the programmed illumination. In FIG. 12B, the image on the LCD is changed so that an environment map from a cathedral is used instead. The 3D image of FIG. 12B thus appears to be illuminated by the new environmental illumination.

Yet another embodiment is directed to a method and system for performing holographic photography conservation. The system can be used to study the degradation of holographic emulsions in works stored at various locations around the world (e.g., the MIT Museum, etc.). In such an embodiment, instrumentation techniques can be used to document the 3D images recorded on holograms stored in a collection. Established imaging techniques can also be used to study the material properties of the holograms and provide a conservation study of holographic film-based media.

The photographic information embedded in a hologram is in the form of interference fringes that are on the order of 1-2 microns. To view a hologram, the recorded interference pattern is reconstructed by illuminating the hologram with the appropriate illumination. A photograph only captures a small portion of the information encoded in a hologram. However, it is possible to record the entire 3D wavefront produced by a hologram, if imagery can be captured with a resolution on the order of 1-2 microns. In the past, digital recording of the interference pattern encoded on a hologram was not considered possible. However, high resolution digital cameras are now widely prolific and inexpensive. Typically, acquisition of 3D wave fronts involves an interferometry setup which can only performed in a laboratory setting and is therefore impractical for transporting to a museum for conservation purposes. However, ptychographic imaging techniques for acquiring reconstructing 3D wave fronts without interferometry have been developed, and the principle has been demonstrated in both optical and X-ray wavelengths.

In one embodiment, a ptychography instrument can be developed that includes just a laser, focusing optics, a high-resolution focal plane array, a 2D scanning gantry, and associated control electronics/software. The ptychography instrument can be a small modification to a 2D scanning gantry. Ptychography algorithms previously developed can be used to reconstruct 3D wave fronts from diffraction patterns captured using the scanning gantry.

Additionally, commercial imaging and material characterization instruments can be used to study the 3D chemical composition of the photochemical materials in holograms. In particular, two main imaging modalities can be used, whose complimentary information will be fused together to better understand the materials structure, and how it relates to the physical appearance, and hence the experience of the viewer. In one implementation, portable scanning X-Ray Fluorescence (XRF) instrument can be used in concert with a portable scanning Optical Coherence Tomography (OCT) imager to probe the selection of holograms. The XRF and OCT imagery can be captured of the same region, either scanned simultaneously with the same gantry, or aligned using imager registration software. The XRF instrument provides access to elemental composition of materials, providing information about the relative concentration of these materials. The OCT instrument will provide information of the 3D structure of the density of materials. The XRF and OCT information can be fused to develop a complete picture of the 3D material structure of regions of the hologram. Comparative studies across different holograms will allow one to probe material structures that are correlated with different stages of deterioration.

The embodiments described herein can be used to develop single color or full-color holographic displays. Additionally, larger display sizes (e.g. 1 m×1 m) can be used. Incorporating multiple SLMs will also increase the fidelity of projected 3D display imagery over larger display sizes. In alternative embodiments, other variations and extensions are also envisioned.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A three-dimensional (3D) display system comprising:
a reference spatial light modulator configured to generate a reference wavefront;
an object spatial light modulator configured to generate an object wavefront; and
a Hogel basis display positioned between the reference spatial light modulator and the object spatial light modulator, wherein the Hogel basis display is configured to receive the reference wavefront and the object wavefront, and wherein the Hogel basis display is configured to generate a light field based at least in part on interference between the reference spatial light modulator and the object spatial light modulator.

2. The 3D display system of claim 1, further comprising a processor configured to determine a Hogel basis for each Hogel of the Hogel basis display.

3. The 3D display system of claim 2, wherein the processor is configured to access a database of high resolution light fields to determine the Hogel basis.

4. The 3D display system of claim 1, further comprising a stepper that is configured to expose different spatial regions on the Hogel basis display.

5. The 3D display system of claim 1, further comprising a processor configured to record the interference between the reference spatial light modulator and the object spatial light modulator onto the Hogel basis display.

6. The 3D display system of claim 1, further comprising a microlens array positioned between the reference spatial light modulator and the Hogel basis display, wherein the microlens array directs the reference wavefront to the Hogel basis display.

7. The 3D display system of claim 1, wherein the reference spatial light modulator is configured to generate a first light field and wherein the light field generated by the Hogel basis display comprises a second light field.

8. The 3D display system of claim 7, wherein the second light field has a higher resolution than the first light field.

9. The 3D display system of claim 1, further comprising a diffuser, wherein the object spatial light modulator is positioned between the Hogel basis display and the diffuser.

10. The 3D display system of claim 1, wherein the reference spatial light modulator is configured to display a grid of pixels, and wherein the reference wavefront results from the grid of pixels.

11. The 3D display system of claim 1, wherein the object spatial light modulator is configured to display an angular spectrum basis, and wherein the object wavefront results from the angular spectrum basis.

12. A method of displaying 3D objects, the method comprising:
generating, by a reference spatial light modulator, a reference wavefront;
generating, by an object spatial light modulator, an object wavefront; and
receiving, by a Hogel basis display positioned between the reference spatial light modulator and the object spatial light modulator, the reference wavefront and the object wavefront; and
generating, by the Hogel basis display, a light field based at least in part on interference between the reference spatial light modulator and the object spatial light modulator.

13. The method of claim 12, further comprising determining, by a processor, a Hogel basis for each Hogel of the Hogel basis display.

14. The method of claim 13, further comprising accessing, by the processor, a database of high resolution light fields to determine the Hogel basis.

15. The method of claim 12, further comprising exposing, by a stepper, different spatial regions on the Hogel basis display.

16. The method of claim 12, further comprising recording, by a processor, the interference between the reference spatial light modulator and the object spatial light modulator onto the Hogel basis display.

17. The method of claim 12, further comprising generating, by the reference spatial light modulator, a first light field, wherein the light field generated by the Hogel basis display comprises a second light field, and wherein the second light field has a higher resolution than the first light field.

18. The method of claim 12, further comprising displaying, by the reference spatial light modulator, a grid of pixels, wherein the reference wavefront results from the grid of pixels.

19. The method of claim 12, further comprising displaying, by the object spatial light modulator, an angular spectrum basis, wherein the object wavefront results from the angular spectrum basis.

20. The method of claim 12, further comprising simultaneously shifting an image on the reference spatial light modulator and displaying a new image on the object spatial light modulator.
